(19) United States
(12) Patent Application Publication
(10) Pub. No.: US 2006/0097647 A1
(43) Pub. Date: May 11, 2006

(54) Plasma display panel

(75) Inventors: Sungyong Ahn, Chilgok-gun (KR); Sungho Woo, Dong-gu (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 11/248,586

(22) Filed: Oct. 13, 2005

(30) Foreign Application Priority Data
Oct. 14, 2004 (KR) 2004-0082241

(51) Int. Cl. G09G 3/10

(52) U.S. Cl. 315/169.4

(57) ABSTRACT

The present invention relates to a plasma display panel. The plasma display panel according to an embodiment of the present invention comprises a front substrate and a rear substrate which are combined together with a predetermined distance therebetween, and one or more first phosphor layers that partition one or more discharge cells between the front substrate and the rear substrate. The plasma display panel according to the present invention are advantageous in that they reduce manufacturing costs and display images with high resolution.

### CROSS-REFERENCES TO RELATED APPLICATIONS

This Nonprovisional application claims priority under 35 U.S.C. § 119(a on Patent Application No. 10-2004-0082241 filed in Korea on Oct. 14, 2004, the entire contents of which are hereby incorporated by reference.

### BACKGROUND OF THE INVENTION

1. Field of the Invention

The present invention relates to a plasma display panel.

2. Background of the Related Art

In general, a conventional plasma display panel comprises ubstrate and a rear substrate. Barrier ribs formed between the front substrate and the rear substrate form one unit cell. Each cell is filled with a primary discharge gas, such as neon (Ne), helium (He) or a mixed gas of Ne and He, and an inert gas containing a small amount of xenon (Xe). If the inert gas is discharged with a high frequency voltage, vacuum ultraviolet rays are generated. The vacuum ultraviolet rays excite phosphors formed between the barrier ribs, thereby displaying images. This plasma display panel can be manufactured to be thin and has thus been considered one of the next-generation display devices.

FIGS. 1 and 2 illustrate a conventional plasma display panel. FIG. 1 is a perspective view showing the construction of a conventional plasma display panel. FIG. 2 is a sectional view of the conventional plasma display panel. In FIG. 2, the front substrate and the rear substrate are rotated with respect to each other by 90° to facilitate understanding of the structure of the plasma display panel.

Referring to FIGS. 1 and 2, a discharge cell of a three-electrode AC surface discharge type plasma display panel comprises scan electrodes Y and sustain electrode Z formed on a bottom surface of an front substrate 10, and an address electrode X formed on a rear substrate 18. Each scan electrode Y comprises a transparent electrode 12Y, and a bus electrode 13Y, which has a line width narrower than that of the transparent electrode 12Y and is disposed at one side of the transparent electrode. Each sustain electrode Z comprises a transparent electrode 12Z, and a bus electrode 13Z, which has a line width narrower than the line width of transparent electrode 12Z and is disposed at one side of the transparent electrode.

The transparent electrodes 12Y and 12Z are generally formed of Indium Tin Oxide (ITO) and are formed on the bottom surface of the front substrate 10. The bus electrodes 13Y and 13Z are generally formed of metal, such as chromium (Cr), and are formed on the transparent electrodes 12Y and 12Z, respectively. The bus electrodes 13Y and 13Z function to reduce a voltage drop incurred by the transparent electrodes 12Y and 12Z with high resistance.

A light-shielding layer 30 corresponding to a width of the bus electrode 13Y is formed between the transparent electrode 12Y and the bus electrode 13Y. A light-shielding layer 30 corresponding to a width of the bus electrode 13Z is also formed between the transparent electrode 12Z and the bus electrode 13Z. The light-shielding layer 30 is formed of a black material and functions to prevent light, which is externally incident on the bus electrodes 13Y and 13Z, from being emitted again outwardly. In other words, the light-shielding layer 30 prevents externally incident light from being emitted outwardly by absorbing the incident light, thus preventing a decrease in the contrast of a plasma display panel.

A front dielectric layer 14 and a protection layer 16 are laminated on the bottom surface of the front substrate 10 in which the scan electrodes Y and the sustain electrode Z are formed in parallel. Wall charges generated during the discharge of plasma are accumulated on the front dielectric layer 14. The protection layer 16 serves to prevent damages to the front dielectric layer 14 due to sputtering generated during the discharge of plasma, and improve emission efficiency of secondary electrons. The protection layer 16 is generally formed of magnesium oxide (MgO).

A rear dielectric layer 22 and barrier ribs 24 are formed on a top surface of the rear substrate 18 in which the address electrode X is formed. The address electrode X is formed to intersect the scan electrodes Y and the sustain electrode Z. The barrier ribs 24 are formed in stripe or lattice form and serve to prevent ultraviolet rays and a visible light generated during a discharge from leaking to adjacent discharge cells. The phosphor layer 26 is excited with ultraviolet rays generated during the discharge of plasma to generate any one of a red, green or blue visible light. A mixed inert gas is injected into the discharge spaces provided between the front substrate 10 and the barrier ribs 24 and the rear substrate 18 and the barrier ribs 24.

Black layers 32 are formed at the interfaces of the discharge cells. The black layers 32 absorb external incident light and light that is radiated from the discharge cells to the outside, thus preventing a decrease in the contrast of the plasma display panel.

In this conventional plasma display panel, to ensure high resolution per same area, the density of discharge cells must be increased. As a result, the size of the discharge cells will be reduced. If the size of discharge cells is reduced, however, the discharge space is also reduced, which will make it difficult to secure a discharge space where appropriate brightness can be sufficiently generated. In view of the above, there is a need for techniques in which the size of discharge cells can be decreased while maintaining the discharge space of plasma in the same area.

### SUMMARY OF THE INVENTION

Accordingly, the present invention has been made in view of the above problems occurring in the prior, and it is an object of the present invention to provide a plasma display panel, in which high-resolution images can be displayed.

It is another object of the present invention to provide a plasma display panel, in which the manufacturing costs can be reduced.

A plasma display panel according to an embodiment of the present invention comprises a front substrate and a rear substrate which are combined together with a predetermined distance therebetween, and one or more first phosphor layers that partition one or more discharge cells between the front substrate and the rear substrate

A plasma display panel according to another embodiment of the present invention comprises a front substrate and a rear substrate which are combined together with a predetermined distance therebetween, one or more first phosphor layers for partitioning discharge cells between the front substrate and the rear substrate, and barrier ribs formed on the rear substrate for every R, G and B unit discharge cell.

In a plasma display panel in accordance with the present invention, barrier ribs that had been partially required in the related art are partially obviated. Therefore, the present invention is advantageous in that it can reduce manufacturing costs.

A plasma display panel in accordance with the present invention are advantageous in that they can display images with high resolution since the number of discharge cells per same area is increased.

A plasma display panel in accordance with the present invention are advantageous in that they can improve the white balance.

### BRIEF DESCRIPTION OF THE DRAWINGS

Further objects and advantages of the invention can be more fully understood from the following detailed description taken in conjunction with the accompanying drawings in which:

FIG. 1 is a perspective view showing the construction of a conventional plasma display panel;

FIG. 2 is a sectional view of the conventional plasma display panel;

FIG. 3 showes the construction of a plasma display apparatus according to an embodiment of the present invention;

FIG. 4 is a sectional view of a plasma display panel according to an embodiment of the present invention;

FIG. 5 illustrates a modified structure of the plasma display panel according to an embodiment of the present invention;

FIG. 6 illustrates another modified structure of the plasma display panel according to an embodiment of the present invention;

FIG. 7 illustrates further another modified structure of the plasma display panel according to an embodiment of the present invention;

FIG. 8 is a sectional view of a plasma display panel according to another embodiment of the present invention; and

FIGS. 9a to 9m illustrate a manufacturing process of a plasma display panel according to an embodiment of the present invention.

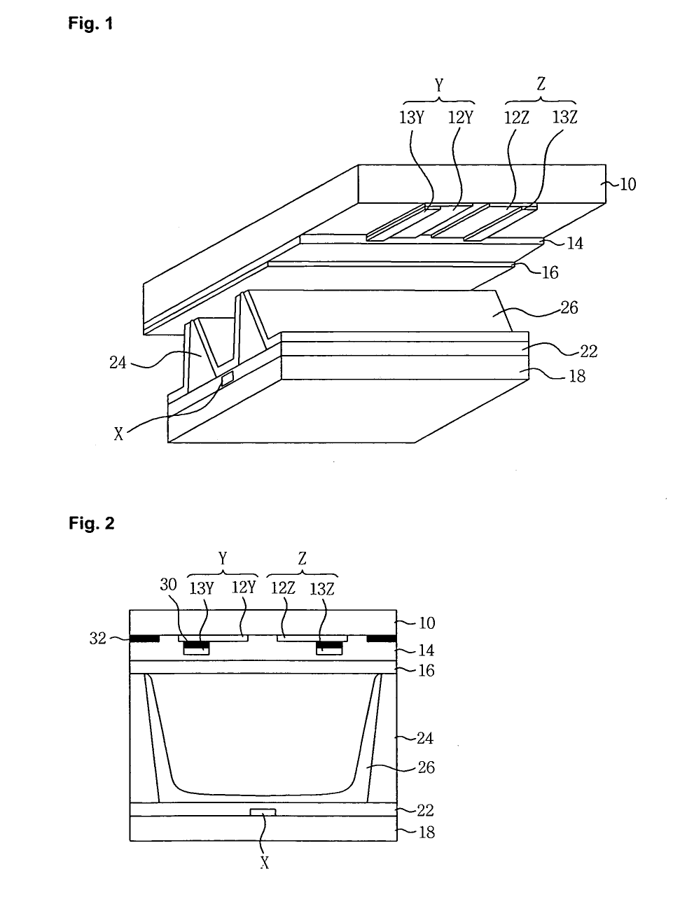

### DETAILED DESCRIPTION OF THE PREFERRED EMBODIMENT

The present invention will now be described in detail in connection with preferred embodiments with reference to the accompanying drawings.

A plasma display panel according to an embodiment of the present invention comprises a front substrate and a rear substrate which are combined together with a predetermined distance therebetween, and one or more first phosphor layers that partition one or more discharge cells between the front substrate and the rear substrate.

One or more discharge cells may be partitioned by the first phosphor layers and barrier ribs on which the phosphor layers are coated.

One or more discharge cells may be partitioned by two barrier ribs on which the phosphor layer are coated.

One or more first phosphor layers may intersect the second phosphor layers that partition the discharge cell in a direction different from a direction in which one or more first phosphor layers are formed, or barrier ribs.

A thickness of the first phosphor layers may be more than the thickness of a phosphor layer of the discharge cell.

A thickness of the first phosphor layers or the second phosphor layers may be more than 80% to less than 100% of a thickness of the barrier ribs formed on a rear substrate.

The first phosphor layers or the second phosphor layers may be comprised of different materials on either side of a partition.

The first phosphor layers or the second phosphor layers may have an different excited wavelengths on either side of a partition.

The pitch of the discharge cells partitioned by the first phosphor layers may be different from each other.

The pitch of the discharge cell may be large in a B discharge cell or a G discharge cell and is small in an R discharge cell.

The first phosphor layers may have different widths on the basis of a partition.

The width may be small in a B discharge cell region or a G discharge cell region and is large in an R discharge cell region.

The first phosphor layers or the second phosphor layers may comprise a barrier rib material.

The barrier rib material present in a material forming the first phosphor layers or the second phosphor layers may be 50% or less of a total percentage of the material forming the first phosphor layers or the second phosphor layers.

The first phosphor layers may have black layers formed at its top end.

The black layers may have an asymmetrical length with respect to a partition of the first phosphor layers.

The front substrate may comprise scan electrodes and sustain electrodes, which are spaced apart from each other at predetermined distances for every discharge cell and arranged in parallel, one or more dielectric layers covering the scan electrodes and the sustain electrodes, and a protection layer covering to protect the dielectric layer.

The rear substrate may comprise address electrodes arranged every discharge cell in parallel, and a dielectric layer covering the address electrodes.

A plasma display panel according to another embodiment of the present invention comprises a front substrate and a rear substrate which are combined together with a predetermined distance therebetween, one or more first phosphor layers for partitioning discharge cells between the front substrate and the rear substrate, and barrier ribs formed on the rear substrate for every R, G and B unit discharge cell.

One or more first phosphor layers intersect second phosphor layers that partition the discharge cell in a direction different from a direction in which one or more first phosphor layers are formed, or barrier ribs.

Next, a plasma display panel in accordance with the present invention will be described below in detail with reference to accompanied drawings.

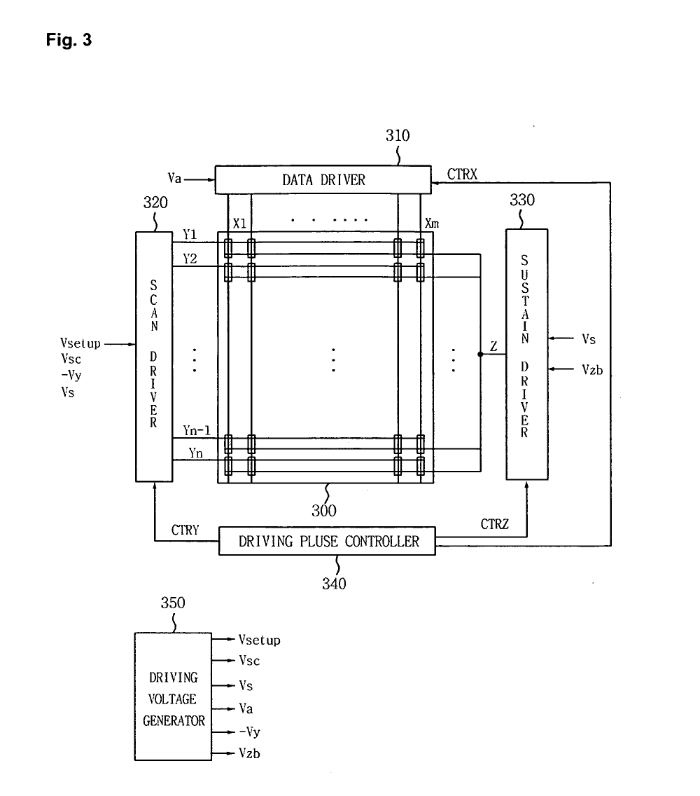

FIG. 3 showes the construction of a plasma display apparatus according to an embodiment of the present invention.

As shown in FIG. 3, the plasma display apparatus according to an embodiment of the present invention comprises a plasma display panel 300, a data driver 310 for driving the plasma display panel 300, a scan driver 320, a sustain driver 330, a driving pulse controller 340 and a driving voltage generator 350.

The plasma display panel 300 comprises a front substrate (not shown) and a rear substrate (not shown), which are adhered together. A plurality of scan electrodes Y1 to Yn and a sustain electrode Z are formed in the front substrate in pairs. A plurality of address electrodes X1 to Xm crossing the scan electrodes Y1 to Yn and the sustain electrodes Z is formed in the rear substrate.

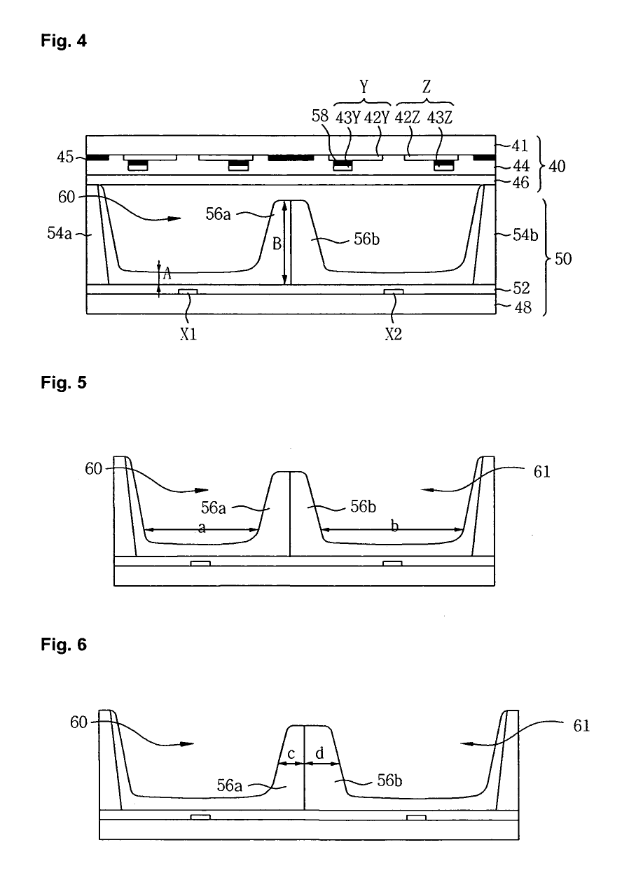

The plasma display apparatus according to an embodiment of the present invention includes a phosphor layer (not shown) that partitions discharge spaces formed between the front substrate and the rear substrate. This will be described in detail with reference to FIGS. 4 to 9m later on.

The data driver 310 applies data to the address electrodes X1 to Xm formed in the plasma display panel 300. The data refers to the picture signal data that has been processed by a picture signal processor (not shown) that processes externally input picture signals. The data driver 310 samples and latches the data in response to a data timing control signal (CTRX) from the driving pulse controller 340 and supplies an address pulse having an address voltage (Va) to the address electrodes X1 to Xm.

The scan driver 320 drives the scan electrodes Y1 to Yn formed in the plasma display panel 300. The scan driver 320 supplies a set-up pulse and a set-down pulse, which constitute a ramp waveform through a combination of Vs, Vsetup and −Vy that are applied from the driving voltage generator 350, to the scan electrodes Y1 to Yn during a reset period under the control of the driving pulse controller 340. The scan driver 320 then sequentially supplies the scan pulses, which are applied from a scan reference voltage (Vsc) to the scan voltage (−Vy), to the scan electrodes Y1 to Yn, respectively, during an address period under the control of the driving pulse controller 340. The scan driver 320 then supplies a least one or more sustain pulses for a sustain discharge, which are supplied from a ground (GND) level to a sustain voltage (Vs), to the scan electrodes Y1 to Yn during a sustain period during an address period under the control of the driving pulse controller 340.

The sustain driver 330 drives the sustain electrode Z, i.e., a common electrode to the plasma display panel 300. The sustain driver 330 supplies a bias voltage (Vzb), which is applied from the driving voltage generator 350, to the scan electrode Z during the address period during an address period under the control of the driving pulse controller 340. The sustain driver 330 then supplies at least one or more sustain pulses for a sustain discharge, which are supplied from the ground (GND) level to the sustain voltage (Vs), to the scan electrodes Z during a sustain period under the control of the driving pulse controller 340.

The driving pulse controller 340 controls the data driver 310, the scan driver 320 and the sustain driver 330 when the plasma display panel 300 is driven. That is, the driving pulse controller 340 generates timing control signals (CTRX, CTRY and CTRZ) for controlling the operation timing and synchronization of the data driver 310, the scan driver 320 and the sustain driver 330 in the reset period, the address period, the sustain period, and transmits the timing control signals (CTRX, CTRY and CTRZ) to the drivers 310, 320 and 330, respectively.

The data control signal (CTRX) comprises a sampling clock for sampling data, a latch control signal, and a switching control signal for controlling an on/off time of an energy recovery/supply unit and a driving switch element within the data driver 310. The scan control signal (CTRY) comprises a switching control signal for controlling an on/off time of an energy recovery/supply unit and a driving switch element within the scan driver 320. The sustain control signal (CTRZ) comprises a switching control signal for controlling an on/off time of an energy recovery/supply unit and a driving switch element within the sustain driver 330.

The driving voltage generator 350 generates driving voltages necessary for the driving pulse controller 340 and the respective drivers 310, 320 and 330 and supplies the generated driving voltages thereto. That is, the driving voltage generator 350 generates the set-up voltage (Vsetup), the scan reference voltage (Vsc), the scan voltage (−Vy), the sustain voltage (Vs), the address voltage (Va) and the bias voltage (Vzb). Control of these driving voltages depends on the composition of the discharge gas or the structure of a discharge cell.

FIG. 4 illustrates a plasma display panel according to an embodiment of the present invention. FIG. 4 is a sectional view of a plasma display panel according to an embodiment of the present invention. A front panel 40 and a rear panel 50 are rotated with respect to each other by 90° facilitate understanding of the structure of a discharge cell.

As shown in FIG. 4, the discharge cell of the plasma display panel according to an embodiment of the present invention comprises a front panel 40 and a rear panel 50.

The front panel 40 comprises a front substrate 41, and scan electrodes Y and sustain electrodes Z formed in the front substrate 41. The scan electrode Y comprises a transparent electrode 42Y and a bus electrode 43Y, which has a line width narrower than the line width of the transparent electrode 42Y and is formed at one side of the transparent electrode 42Y. The sustain electrode Z comprises a transparent electrode 42Z and a bus electrode 43Z, which has a line width narrower than the line width of the transparent electrode 42Z and is formed at one side of the transparent electrode 42Z.

The transparent electrodes 42Y, 42Z are formed of ITO and are formed on the front substrate 41. The bus electrodes 43Y and 43Z are formed of metal, such as chrome (Cr), and are formed on the transparent electrodes 42Y and 42Z. The bus electrodes 43Y and 43Z serve to function to reduce the voltage drop incurred by the transparent electrodes 42Y and 42Z with high resistance.

A light-shielding layer 58 corresponding to a width of the bus electrode 43Y is formed between the transparent electrode 42Y and the bus electrode 43Y. A light-shielding layer 58 corresponding to a width of the bus electrode 43Z is also formed between the transparent electrode 42Z and the bus electrode 43Z. The light-shielding layer 58 is formed of a black material and functions to prevent light, which is externally incident on the bus electrodes 43Y and 43Z, from being radiated again outwardly. In other words, the light-shielding layer 58 prevents externally incident light from being emitted outwardly by absorbing the incident light, thus preventing a decrease in the contrast of a plasma display panel.

A front dielectric layer 44 and a protection layer 46 are laminated on the bottom surface of the front substrate 41 in which the scan electrodes Y and the sustain electrodes Z are formed in parallel. Wall charges generated during the discharge of plasma are accumulated on the front dielectric layer 44. The protection layer 46 to prevents damage to the front dielectric layer 44, which can be incurred by sputtering generated during the discharge of plasma, and enhance emission efficiency of the secondary electrons. The protection layer 46 is usually formed of magnesium oxide (MgO).

Black layers 45 are formed at the interfaces of the discharge cells. The black layers 45 absorb external incident light and light that is radiated from the discharge cells to the outside, thus preventing a decrease in the contrast of the plasma display panel.

The rear panel 50 comprises a rear substrate 48, address electrodes X1 and X2 formed on the rear substrate 48, and a rear dielectric layer 52 formed on the rear substrate 48 and the address electrodes X1 and X2, and barrier ribs 54a and 54b. On surfaces of the rear dielectric layer 52 and the barrier ribs 54a and 54b are formed two or more phosphor layers 56a and 56b whose excited wavelengths are different from each other. The address electrodes X1 and X2 cross the scan electrode Y and the sustain electrodes Z.

The barrier ribs 54a and 54b are formed in stripe or lattice form, and to prevent ultraviolet rays and/or a visible ray, which are generated by a discharge, from leaking to adjacent discharge cells. The barrier ribs 54a and 54b support discharge spaces when the front panel 40 and the rear panel 50 are adhered together.

The phosphor layers 56a and 56b are formed on the barrier ribs 54a and 54b and the rear dielectric layer 52 and are excited by ultraviolet rays, which are generated during the discharge of plasma, to generate any one of R (red), G (green) or B (blue) visible rays. The phosphor layers 56a and 56b according to an embodiment of the present invention partition discharge spaces between the front substrate 41 and the rear substrate 48, which are combined together with a predetermined distance therebetween. In the present embodiment, two discharge spaces are partitioned.

This will be described below in detail. The first barrier rib 54a is formed between two or more discharge spaces. The second barrier rib 54b is adjacent to the first barrier rib 54a. Each of the two discharge spaces comprises the address electrodes X1 and X2. The rear dielectric layer 52 covering the address electrodes X1 and X2 is formed in each discharge space. The phosphor layers 56a and 56b, being comprised of different materials, i.e., excited wavelengths are different from each other, are formed in discharge spaces adjacent to each other, respectively.

In the case where the phosphor layers 56a and 56b whose excited wavelengths are at least two or more are formed between the first and second barrier ribs 54a and 54b, the phosphor layers 56a and 56b have a step between a region to which the discharge spaces belong and a region that partitions the discharge spaces.

That is, a thickness (B) of the phosphor layers 56a and 56b that partition the discharge spaces is more than a thickness (A) of a phosphor layer belonging to the discharge space, so that the discharge spaces are partitioned. The term “phosphor layer” partitioning discharge spaces refers to a phosphor layer serving as a kind of a barrier rib that partitions R, G and B discharge cells only with the phosphor layer itself without the structure of barrier ribs.

Therefore, although barrier ribs are not formed at the interfaces of the phosphor layers 56a and 56b partitioning the discharge spaces in FIG. 4, a phosphor layer formed on an opposite side is formed on the barrier ribs 54a and 54b. It is therefore possible to secure a sufficient discharge space even without reducing the size of a discharge cell since a portion where conventional barrier ribs are formed serves as a reserved space. Therefore, when a pitch in a plasma display panel of the present invention is the same as that of a discharge cell in the conventional plasma display panel, the number of discharge cells integrated on the plasma display panel according to an embodiment of the present invention is increased.

The maximum thickness of the phosphor layers 56a and 56b belonging to a region that partitions discharge spaces is from more than 50% to less than 100% of the maximum thickness of the barrier ribs 54a and 54b. If the maximum thickness is 50% or less, respective discharge spaces are not clearly partitioned, which may abruptly increase cross talk toward adjacent discharge cells. If the maximum thickness is 100% or higher, this may lower the convenience of a manufacturing process and degrade an exhaust characteristic of impurities. In consideration of such cross talk between discharge cells, the maximum thickness of the phosphor layers 56a and 56b that partition discharge spaces should not be less than 80% with respect to the maximum thickness of the barrier ribs 54a and 54b. To improve an exhaust characteristic while reducing cross talk, the center of a top surface of the phosphor layers 56a and 56b that partition the discharge space groove.

A width of the phosphor layers 56a and 56b that partition discharge spaces is wider than the width of the phosphor layers formed on the barrier ribs 54a, 54b.

In the present embodiment, the phosphor layers 56a and 56b that partition the discharge spaces can comprise a barrier rib material to secure rigidity. To maintain a phosphor characteristic, the barrier rib material present in a material forming the phosphor layers 56a and 56b should be 50% or less of a total percentage of the material forming the phosphor layers 56a and 56b. A glass ceramics material can be used as the barrier rib material.

In the present embodiment, as shown in FIG. 4, the discharge space 60 partitioned by the phosphor layers 56a and 56b between the two barrier ribs 54a and 54b is two in number. However, the present invention can be applied to a case where the number of the discharge space 60 partitioned by the phosphor layers 56a and 56b between both barrier ribs 54a and 54b is 2 or higher. In addition, one address electrode is disposed in each of the discharge spaces 60.

FIG. 5 illustrates a modified structure of the plasma display panel according to an embodiment of the present invention.

As shown in FIG. 5, in the modified structure of the plasma display panel according to an embodiment of the present invention, widths of the discharge spaces partitioned by phosphor layers are different from each other.

The phosphor layers whose materials, i.e., excited wavelengths are different from each other are formed in adiacent discharge spaces. Each of the phosphor layers becomes one of R, G or B phosphor layers. Since the R, G or B phosphor layers have different saturation characteristics, they have different brightness characteristics although the number of sustain pulses applied to respective discharge spaces is the same. Therefore, in the present embodiment, the widths of the discharge spaces are formed to be different from each other by taking the brightness characteristics of the phosphor layers into consideration.

For example, in the case where two discharge spaces 60, 61 are formed as shown in FIG. 5, a width (b) of a discharge space of a phosphor layer 56b with a low brightness characteristic, of the phosphor layers 56a and 56b of the discharge spaces 60 and 61, is wider than a width (a) of a discharge space of the phosphor layer 56a with a high brightness characteristic. Therefore, when forming phosphor layers, discharge spaces can be partitioned and white balance can also be controlled.

Furthermore, in the present embodiment, as shown in FIG. 6, white balance can be controlled using not only discharge spaces, but also regions that partition the discharge spaces.

FIG. 6 is a view for illustrating another modified structure of the plasma display panel according to an embodiment of the present invention.

As shown in FIG. 6, in the present embodiment, at least two or more discharge spaces are partitioned by phosphor layers. In the case where regions partitioning the discharge spaces are formed using one kind of a material, mixed light is generated by the material of the regions that partitions the discharge spaces when discharge light is generated in an opposite discharge space having a different material unlike discharge spaces having the same material. For this reason, phosphor layers according to an embodiment of the present invention are formed of two different materials in regions that partition discharge spaces. Preferably, the material is the same as that of a phosphor layer of each of neighboring discharge spaces with respect to the regions partitioning the discharge spaces.

In another modified structure of a plasma display panel according to an embodiment of the present invention, the widths of the phosphor layers formed using two kinds of materials are different from each other in regions that partition discharge spaces. That is, the widths of the regions that partition the discharge spaces are formed to be different from each other in consideration of a brightness characteristic of regions that partition discharge spaces formed using different materials. By controlling the widths of regions that partition discharge spaces, brightness of a visible ray radiated through a top surface of the regions that partitions the discharge spaces is controlled.

For example, in the case where two discharge spaces 60, 61 are formed as shown in FIG. 6, a width (d) of a region that partitions the discharge space of the phosphor layer 56b with a high brightness characteristic, of the phosphor layers 56a and 56b of the discharge spaces 60 and 61, is wider than a width (c) of the region that partitions the discharge space of the phosphor layer 56a with a low brightness characteristic. A pitch of a discharge cell with a high brightness characteristic becomes lower than that of a discharge cell with a low brightness characteristic. As a result, upon formation of a phosphor layer, not only discharge spaces are partitioned, but also white balance will be controlled.

FIG. 7 illustrates another modified structure of the plasma display panel according to an embodiment of the present invention.

As shown in FIG. 7, in another modified structure of the plasma display panel according to an embodiment of the present invention, black layers are formed on regions that partition discharge spaces of phosphor layers. In the aforementioned embodiment of the present invention, the black layers are formed on the front panel, as shown in FIG. 4. In another modified structure, however, unlike FIG. 4, black layers 70 and 71 are formed on barrier ribs 54a and 54b, or a black layer 72 is formed on a region that partitions a discharge space of the phosphor layers 56a and 56b, as shown in FIG. 7. As described above, if the black layer 72 is formed in the region that partitions the discharge space of the phosphor layers 56a and 56b, a mixed color between adjacent discharge cells will be prevented and a manufacturing process of the black layers can be facilitated.

By setting the widths of the black layers 72, which are formed in regions that partition the discharge spaces, to be different from each other, the degree of shielded light emitted from a top surface of a region that partitions discharge spaces. For instance, by controlling widths of black layers formed to be different depending on materials of R, G and B phosphor layers, the white balance of a plasma display panel will be controlled. FIG. 7 showes that the black layers 72 are formed in a wider area on the phosphor layer 56a with a high brightness characteristic.

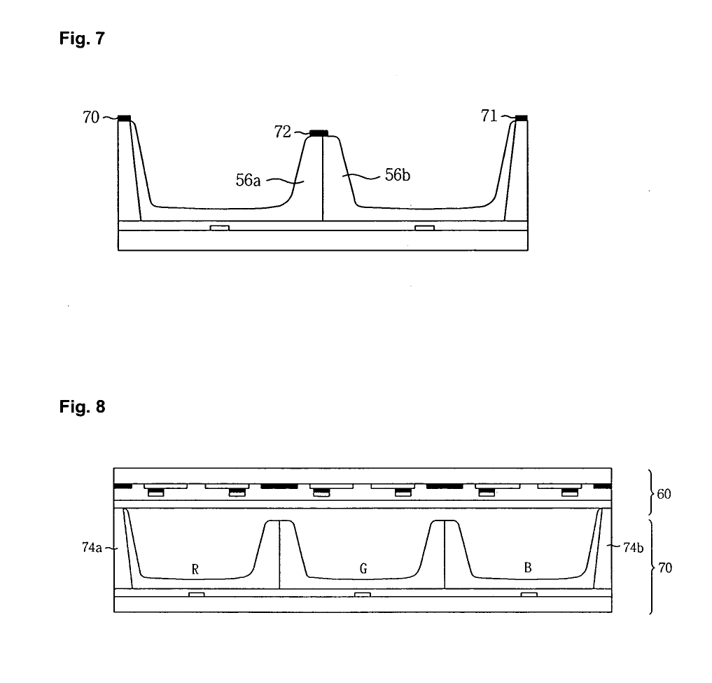

FIG. 8 illustrates plasma display panel according to another embodiment of the present invention. FIG. 8 is a sectional view of the plasma display panel according to another embodiment of the present invention. A front panel 60 and a rear substrate 70 are rotated with respect to each other by 90° to facilitate understanding of the structure of the plasma display panel.

The bundle of R, G and B discharge cells form the least unit that can display a desired color. In the present invention, the least unit that can display a color will be referred to as “R, G and B unit discharge cell.

In accordance with the present invention, it is possibile that the discharge light between adjacent R, G and B unit discharge cells may mix due to large-scale integration. For this reason, in the present embodiment, a barrier rib is formed for every unit discharge cell. For example, as shown in FIG. 8, R, G and B unit discharge cells can be formed between a first barrier rib 74a and a second barrier ribs 74b, and the R, G and B unit discharge cells are partitioned with a step being given to phosphor layers.

Preferably, the barrier ribs 74a and 74b will be thicker than the phosphor layers. Since color interference between the R, G and B unit discharge cells is reduced by the barrier ribs formed between the R, G and B unit discharge cells, the picture quality of images that are implemented can be further improved. In addition, by using the spaces of the conventional barrier ribs that had been formed for every R, G and B discharge cells as surplus spaces, images with high resolution can be implemented.

In the structure of the discharge cell according to another embodiment of the present invention, more surplus spaces can be secured compared with the structure of the discharge cell according to an embodiment of the present invention. It is thus possible to increase the number of discharge cells.

The present invention is not restricted by the embodiment of the plasma display panel having the structure of the phosphor layers that partition the discharge space, which has been described with reference to FIGS. 4 to 8. That is, although a barrier rib can be formed every R, G and B unit discharge cells, a barrier rib can be formed for every two or more R, G and B unit discharge cells.

Barrier ribs may not be formed within a valid display region on which images are displayed, but discharge cells can be partitioned by only phosphor layers. In this case, a phosphor layer located at the outermost of the valid display region can be preferably formed using a barrier rib to support an upper substrate.

The present invention may include various structures of discharge cell. That is, the present invention can be applied to various shapes of discharge cell structures such as a strip type, a well type, a fish bone type, a honeycomb type and a waffle type. For example, in the case of a closed well type, discharge cells are partitioned by four upper, lower, right and left barrier ribs. In this case, a phosphor layer serving as a barrier rib can be formed at any one of upper, lower, right and left places in accordance with the present invention. The number of phosphor layers can also range from 1 to 4.

In the case where a phosphor layer serving as a barrier rib is formed only at one of the upper, lower, right and left positions in a discharge cell, the phosphor layers intersect two barrier ribs. In addition, in the case phosphor layers serving as barrier ribs is formed only at two of the upper, lower, right and left positions in a discharge cell, the phosphor layers can intersect one barrier rib while crossing each other and cross two barrier ribs. Furthermore, a width and/or thickness of the phosphor layers that intersect each other can be substantially the same or different from each other.

Even in the present embodiment, the numerical value of a thickness of phosphor layers, a material of phosphor layers, a width of phosphor layer, formation of black layers and the like can be applied in the same manner as the aforementioned embodiment.

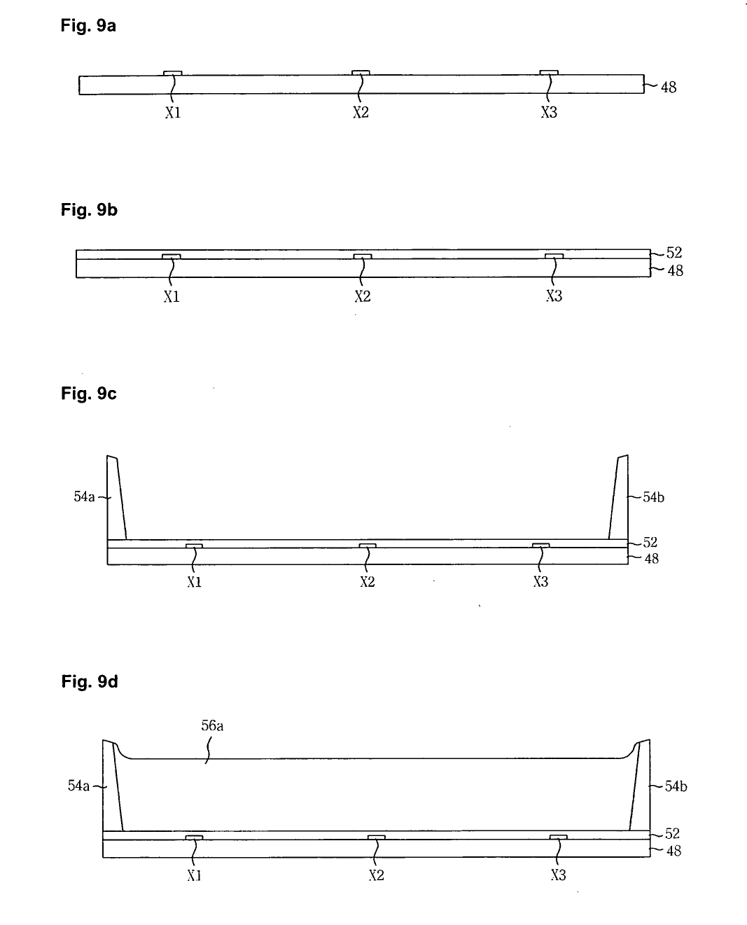

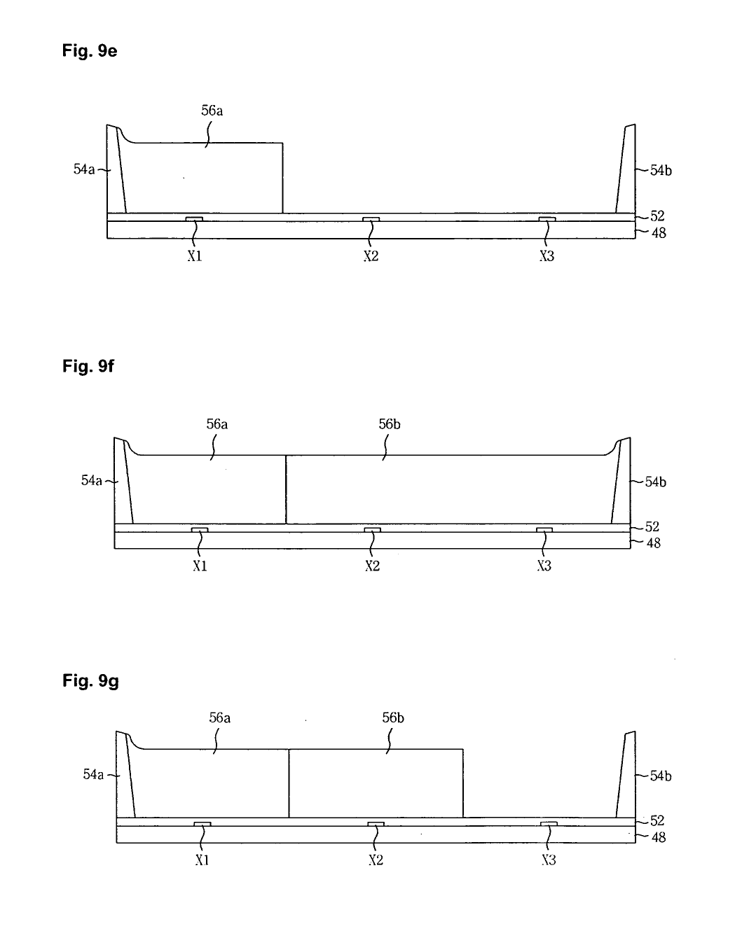

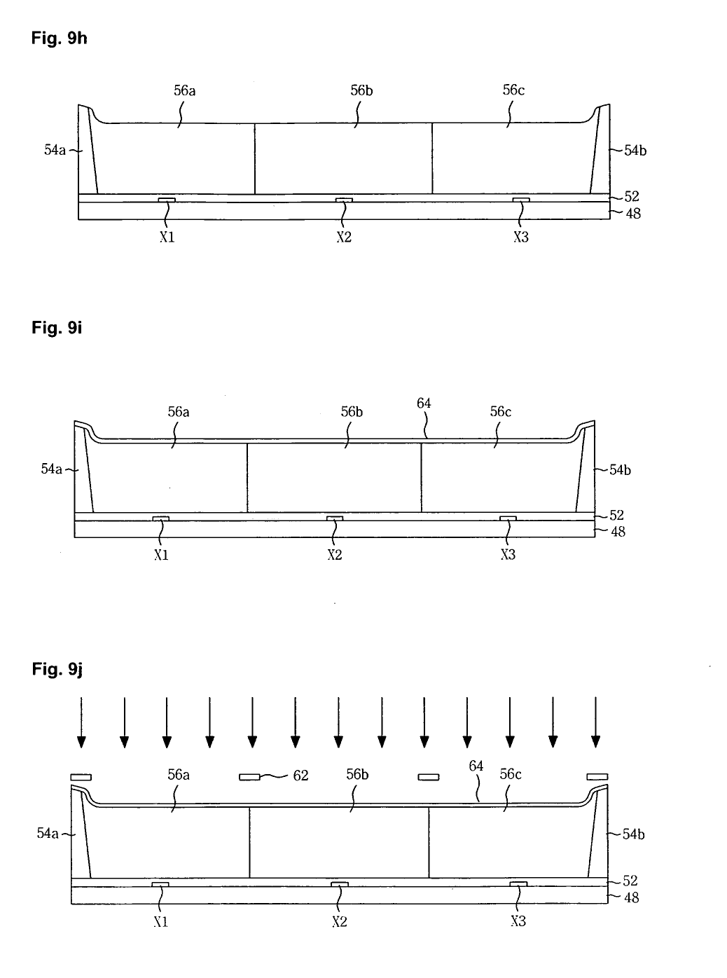

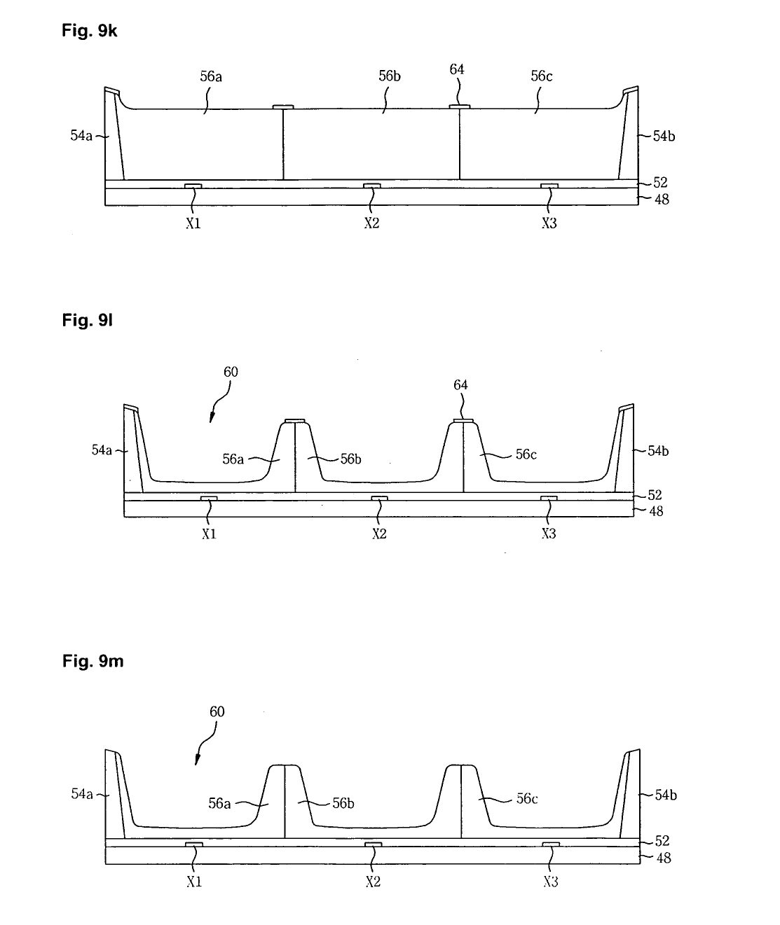

The manufacturing the rear panel, of a manufacturing process of the plasma display panel according to an embodiment of the present invention, will be described with reference to FIGS. 9a to 9m.

FIGS. 9a to 9m illustrate a manufacturing process of a plasma display panel according to an embodiment of the present invention.

Referring to FIG. 9a, address electrodes X1, X2 and X3 are formed on a rear substrate 48 by a photolithography process, etc.

This process will be described in detail. Address electrode layers are deposited as a thin film on the rear substrate 48 by a sputtering or spin and spinless method. A photoresist is then coated on the entire deposited thin film. A screen mask having a shape desired by a user is placed on the coated photoresist. Thereafter, the photoresist other than the masked portions is exposed using ultraviolet rays (UV). The exposed photoresist is developed using a developer. An etch process is then performed to form the address electrodes X1, X2 and X3.

Referring to FIG. 9b, a dielectric material is blanket printed on the rear substrate 48 having the address electrodes X1, X2 and X3 formed thereon, forming a dielectric layer 52.

Referring to FIG. 9c, barrier ribs 54a and 54b are formed on the dielectric layer 52 using one of molding, sandblasting and photolithography methods.

This process will be described below in detail. In the molding method, a mold having an engraving shape of barrier ribs, which will be formed on a green sheet, is pressurized to form the barrier ribs 54a and 54b.

In the sandblasting method, a dry film (i.e., a photosensitive material) is coated on paste for barrier ribs, which is deposited on the entire surface. A mask having the same shape as that of the barrier ribs is disposed. The dry film at a portion that has not been masked is then exposed to ultraviolet rays. The exposed dry film is then developed using a developer. Thereafter, the paste for barrier ribs at the portion in which the dry film has been developed is physically removed by spraying particles, thereby completing the barrier ribs 54a and 54b.

In the photolithography method, a photoresist (i.e., a photosensitive material) is coated on paste for barrier ribs, which is deposited on the entire surface. A mask that has the same shape as that of the barrier ribs is placed. The photoresist that has not been masked is then exposed by irradiating UV onto a top surface of the mask. The exposed photoresist is then developed using a developer. Thereafter, the paste for barrier ribs at a portion in which the photoresist has been developed is removed through chemical reaction of an etching process, thereby completing the barrier ribs 54a and 54b.

First to third phosphor layers are formed between these barrier ribs 54a and 54b through subsequent processes of FIGS. 9d to 9h. In this case, an inkjet spray method, a squeezing method or the like is employed.

Referring to FIG. 9d, a first phosphor paste is coated on the entire surface of the dielectric layer 52 to form a first phosphor layer 56a.

Referring to FIG. 9e, portions other than the first phosphor layer 56a formed on the dielectric layer 52 of the first address electrode X1 are removed by a photolithography process.

Referring to FIG. 9f, a second phosphor paste is coated on regions other than the first phosphor layer 56a, thus forming a second phosphor layer 56b between the first phosphor layer 56a and the barrier ribs 54b.

Referring to FIG. 9g, portions other than the first and the second phosphor layers 56a and 56b formed on the dielectric layer 52 of the first and second address electrodes X1 and X2 are removed.

Referring to FIG. 9h, a third phosphor paste is coated to form a third phosphor layer 56c on the dielectric layer 52 of the third address electrode X3.

If the first to third phosphor layers 56a and 56b and 56c are formed as describe above, a discharge space region and a region for partitioning a discharge space are formed as follows.

Referring to FIG. 9i, a photoresist 64 is coated on the entire surface of the first to third phosphor layers 56a, 56b and 56c.

Referring to FIG. 9j, after masks 62 are arranged, the photoresist 64 at the interfaces of the first to third phosphor layers 56a, 56b and 56c, i.e., portions other than a region that partitions a discharge space is exposed using UV.

Referring to FIG. 9k, the photoresists 64 are developed using a developer.

Referring to FIG. 9l, an etch process is performed to form discharge spaces 60, and the first to third phosphor layers 56a, 56b and 56c that partition the discharge spaces.

Referring to FIG. 9m, the photoresists 64 are stripped using a strip solution, completing a rear panel. Thereafter, a process of forming black layers (not shown) on a region that partitions the discharge spaces of the barrier ribs 54a and 54b or the phosphor layers 56a, 56b and 56c may be further included.

The photolithography process of forming the first to third phosphor layers 56a, 56b and 56c and the photolithography process of forming the discharge spaces, of the manufacturing process of the plasma display panel according to an embodiment of the present invention, can employ a method using other processes for the same object, such as a sandblast process or a process of laminating, exposing developing and etching a dry film. That is, the plasma display panel of the present invention is not restricted by the manufacturing process of the plasma display panel according to an embodiment of the present invention.

These and other objects of the present application will become more readily apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

The invention being thus described, may be varied in many ways. Such variations are not to be regarded as a departure from the spirit and scope of the invention, and all such modifications as would be obvious to one skilled in the art are intended to be included within the scope of the following claims.

What is claimed is:

1. A plasma display panel, comprising:
a front substrate and a rear substrate which are combined together with a predetermined distance therebetween; and
one or more first phosphor layers that partition one or more discharge cells between the front substrate and the rear substrate.

2. The plasma display panel as claimed in claim 1, wherein one or more discharge cells are partitioned by the first phosphor layers and barrier ribs on which the phosphor layers are coated.

3. The plasma display panel as claimed in claim 2, wherein one or more discharge cells are partitioned by two barrier ribs on which the phosphor layer are coated.

4. The plasma display panel as claimed in claim 1, wherein one or more first phosphor layers intersect the second phosphor layers that partition the discharge cell in a direction different from a direction in which one or more first phosphor layers are formed, or barrier ribs.

5. The plasma display panel as claimed in claim 1, wherein a thickness of the first phosphor layers is more the thickness of a phosphor layer of the discharge cell.

6. The plasma display panel as claimed in claim 4, wherein a thickness of the first phosphor layers or the second phosphor layers is from more than 80% to less than 100% of a thickness of the barrier ribs formed on a rear substrate.

7. The plasma display panel as claimed in claim 4, wherein the first phosphor layers or the second phosphor layers may be comprised of different materials on either side of a partition.

8. The plasma display panel as claimed in claim 4, wherein the first phosphor layers or the second phosphor layers may have an different excited wavelengths on either side of a partition.

9. The plasma display panel as claimed in claim 1, wherein pitches of the discharge cells partitioned by the first phosphor layers are different from each other.

10. The plasma display panel as claimed in claim 9, wherein the pitch of the discharge cell is large in a B discharge cell or a G discharge cell and is small in an R discharge cell.

11. The plasma display panel as claimed in claim 1, wherein the first phosphor layers have different widths on the basis of a partition.

12. The plasma display panel as claimed in claim 11, wherein the width is small in a B discharge cell region or a G discharge cell region and the width is large in an R discharge cell region.

13. The plasma display panel as claimed in claim 4, wherein the first phosphor layers or the second phosphor layers comprise a barrier rib material.

14. The plasma display panel as claimed in claim 13, wherein the barrier rib material present in a material forming the first phosphor layers or the second phosphor layers is 50% or less of a total percentage of the material forming the first phosphor layers or the second phosphor layers.

15. The plasma display panel as claimed in claim 1, wherein the first phosphor layers have black layers formed at its top end.

16. The plasma display panel as claimed in claim 15, wherein the black layers have an asymmetrical length with respect to a partition of the first phosphor layers.

17. The plasma display panel as claimed in claim 1, wherein the front substrate comprises:
scan electrodes and sustain electrodes, which are spaced apart from each other at predetermined distances for every discharge cell and arranged in parallel;
one or more dielectric layers covering the scan electrodes and the sustain electrodes; and
a protection layer covering to protect the dielectric layer.

18. The plasma display panel as claimed in claim 1, wherein the rear substrate comprises:
address electrodes arranged every discharge cell in parallel; and
a dielectric layer covering the address electrodes.

19. A plasma display panel, comprising:
a front substrate and a rear substrate which are combined together with a predetermined distance therebetween;
one or more first phosphor layers for partitioning discharge cells between the front substrate and the rear substrate; and
barrier ribs formed on the rear substrate for every R, G and B unit discharge cell.

20. The plasma display panel as claimed in claim 19, wherein one or more first phosphor layers intersect second phosphor layers that partition the discharge cell in a direction different from a direction in which one or more first phosphor layers are formed, or barrier ribs.
